(19) United States
(12) Patent Application Publication
(10) Pub. No.: US 2015/0006080 A1
(43) Pub. Date: Jan. 1, 2015

(54) Solar Power Generation Estimation System, Device, and Method

(71) Applicant: Hitachi, Ltd., Chiyoda-ku, Tokyo (JP)

(72) Inventors: Jun Yamazaki, Tokyo (JP); Yasuo Sato, Tokyo (JP)

(21) Appl. No.: 14/377,100

(22) PCT Filed: Feb. 7, 2013
(86) PCT No.: PCT/JP2013/052849

§ 371 Date: Aug. 6, 2014

(30) Foreign Application Priority Data
Feb. 10, 2012 (JP) 2012-027515

(51) Int. Cl. G01R 31/40; G01W 1/10; G01J 1/42

(52) U.S. Cl. CPC H02S 50/00; G01J 1/4228; G01W 1/10; G01J 2001/4266
USPC 702/3

(57) ABSTRACT

The power generation amount of a PV device is estimated by multiple light receiving devices, which are dispersed in a predetermined area and each of which outputs a receive light signal corresponding to the amount of received light, and by an estimation device connected to the multiple light receiving devices through a communication network. The estimation device predicts the cloud shadow projected on the ground based on the received light signal obtained multiple times from a predetermined number of light receiving devices of the multiple light receiving devices. Then, the estimation device estimates the amount of power generated by the PV device installed in the predetermined area, based on the predicted cloud shadow.

### TECHNICAL FIELD

The present invention relates to a solar power generation estimation system, device, and method for estimating the power generation amount of a photovoltaic power generation device.

In recent years, a photovoltaic power generation device (hereinafter referred to as “PV (photovoltaic) device”) has been installed in home. The power generation amount of the PV device is affected by the change in the amount of solar radiation. In other words, the power generation amount of the PV device is small when the sky above the installation point is covered with clouds, and is large when there are no clouds in the sky above the installation point. Thus, one of the methods for estimating the power generation amount of the PV device is to estimate the cloud distribution and movement direction.

Patent Literature 1 describes a method for proving a 360-degree omni-directional camera at the point where a solar panel is installed to photograph the whole sky, in order to predict the distribution of clouds at a predetermined future time by detecting the distribution and movement of the clouds from the whole sky image.

Patent Literature 2 describes a method for predicting the wind and cloud movement, temperature, and the like, from the weather prediction such as the weather forecast, to predict the power generation amount based on such information.

### CITATION LIST

### Patent Literature

Patent Literature 1: Japanese Unexamined Patent Publication Application No. 2007-184354

Patent Literature 2: Japanese Unexamined Patent Publication Application No. 2010-57262

### SUMMARY OF INVENTION

### Technical Problem

However, in Patent Literature 1, it is necessary to provide the omni-directional camera at each installation point of the solar panel, so that the cost for achieving this method is expensive. In Patent Literature 2, it is difficult to predict the change in the amount of solar radiation in a short time at a predetermined point.

An object of the present invention is to provide a solar power generation estimation system, device, and method for estimating the power generation amount of a PV device by predicting the cloud shadow.

### Solution to Problem

According to an aspect of the present invention, a solar power generation estimation system for estimating the power generation amount of a PV device includes: multiple light receiving devices that are dispersed in a predetermined area and each of which outputs a received light signal according to the amount of received light; and an estimation device connected to the multiple light receiving devices through a communication network. The estimation device predicts the cloud shadow projected on the ground, based on the received light signal obtained multiple times from a predetermined number of light receiving devices of the multiple light receiving devices. Then, the estimation device estimates the amount of power generated by the PV device installed in the predetermined area, based on the predicted cloud shadow.

These and still other objects and advantages of the present invention will become more apparent from the following description of the embodiment of the present invention when taken in conjunction with the accompanying drawings.

### BRIEF DESCRIPTION OF DRAWINGS

FIG. 1 is a schematic diagram of the method for estimating the boundary of the cloud;

FIG. 2 is a schematic diagram of the configuration of a solar power generation estimation system 10;

FIG. 3 is a block diagram showing an example of the functional configuration of a power generation amount estimation device 18;

FIG. 4 is an example of a data table configured in a measurement information DB 26;

FIG. 5 is an example of a data table configured in a point information DB 25;

FIG. 6 is an example of a data table created in a power generation characteristic information DB;

FIG. 7 is a graph showing the temporal transition of the amount of power generated in a PV device 11 at a certain point;

FIG. 8 is a schematic diagram illustrating the wind speed and direction at measurement points;

FIG. 9 is a schematic diagram illustrating decreasing and increasing points at the current time;

FIG. 10 is a schematic diagram illustrating a second constraint;

FIG. 11 is a schematic diagram illustrating a third constraint;

FIG. 12 is a schematic diagram of a method for correcting the boundary line that runs counter to the third constraint;

FIG. 13 is a schematic diagram of a method for determining whether a certain point is inside the closed curve;

FIG. 14 is a flow chart showing an example of a process for the power generation amount estimation device 18 to estimate the predicted power generation amount;

FIG. 15 is a graph showing the temporal transition of the power generation amount when two threshold values for change point direction are set; and

FIG. 16 is a schematic diagram of a variation of frontier points and closed curves at a predicted time.

### DESCRIPTION OF EMBODIMENTS

The present invention is characterized in that an estimation device estimates the boundary of the cloud based on a received light signal that changes according to the received light amount output by a light receiving device installed at each point. The boundary of the cloud is the boundary of the shadow that the cloud creates on the ground. In other words, the boundary of the cloud is the boundary between the shadowed area and the non-shadowed area when the cloud is projected on the ground. Hereinafter, an embodiment according to the present invention will be described with reference to the accompanying drawings.

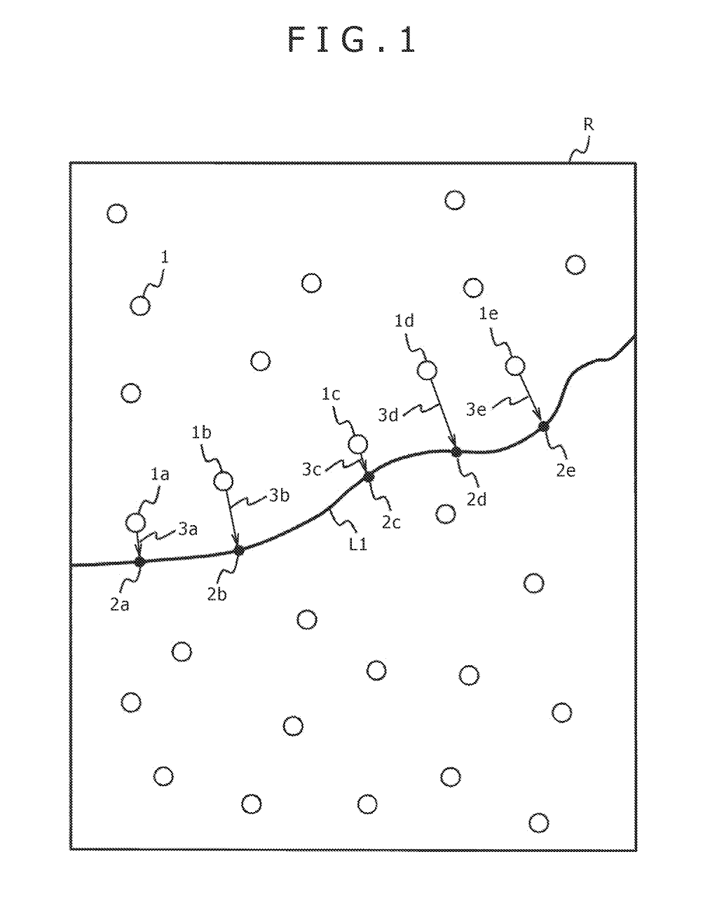

FIG. 1 is a schematic diagram of a method for estimating the boundary of the cloud. In FIG. 1, multiple light receiving devices 1 are dispersed in a predetermined area R.

The light receiving device 1 outputs a received light signal, which is the value that changes according to the amount of the light received from the sun. The light receiving device 1 is, for example, a PV device 11 or a sunshine recorder and the like. The received light signal is, for example, the amount of power generation when the light receiving device 1 is the PV device, or the amount of solar radiation when the light receiving device 1 is the sunshine recorder.

The estimation device analyzes the received light signal obtained multiple times from each of a predetermined number of light receiving devices 1, which are all or part of the multiple light receiving devices 1 installed in the predetermined area R. Then, the estimation device identifies the installation point of the light receiving device 1 that measured the received light signal with a predetermined change, as well as the time when the predetermined change occurs. For example, the predetermined change is the change in which the received light signal increases or decreases more than a predetermined value in a predetermined period of time. Alternatively, for example, the predetermined change is the change in which the received light signal has a predetermined increasing or decreasing trend in a predetermined period of time. With this configuration, the estimation device can estimate that the boundary of the shadow that the cloud creates on the ground (hereinafter also referred to as the boundary of the cloud) passes through the installation point of the light receiving device 1 that measured the predetermined change at the time when the particular predetermined change occurs. A part of the boundary of the cloud passing through the installation point is referred to as the frontier point of the cloud. In this way, the estimation device can estimate the frontier point of the cloud at a certain time, by using the installation point of each light receiving device 1 through which the boundary of the cloud passes, and using the time when the boundary of the cloud passes through the particular installation point. At this time, the estimation device can estimate the direction and distance in which the frontier point of the cloud moves from when it passes through the installation point to a certain time, based on the information on the wind direction and the wind speed. The estimation device is, for example, the power generation amount estimation device 18.

For example, in FIG. 1, it is assumed that the times measured by the light receiving devices 1a, 1b, 1c, 1d, and 1e are T1, T2, T3, T4, and T5. At this time, the estimation device estimates that the boundary of the cloud passes through the point of the light receiving device 1a at the time T1. Then, the estimation device estimates that the frontier point of the cloud passing through the point of the light receiving device 1a at the time T1 moves to the point 2a at a certain time T. Similarly, with respect to the light receiving devices 1b to 1e, the estimation device estimates that the frontier points of the cloud that pass through the respective points at T2 to T5 move to the points 2b to 2e, respectively, at the certain time T. In this way, the estimation device can estimate a boundary line L1 by identifying the frontier points 2a to 2e of the cloud at the certain time T, and by connecting the frontier points 2a to 2e of the cloud by a line. Note that the direction and speed of the destination of the frontier points of the cloud (vectors 3a to 3e in FIG. 1) are estimated, for example, based on the information on the wind direction and speed at the particular points.

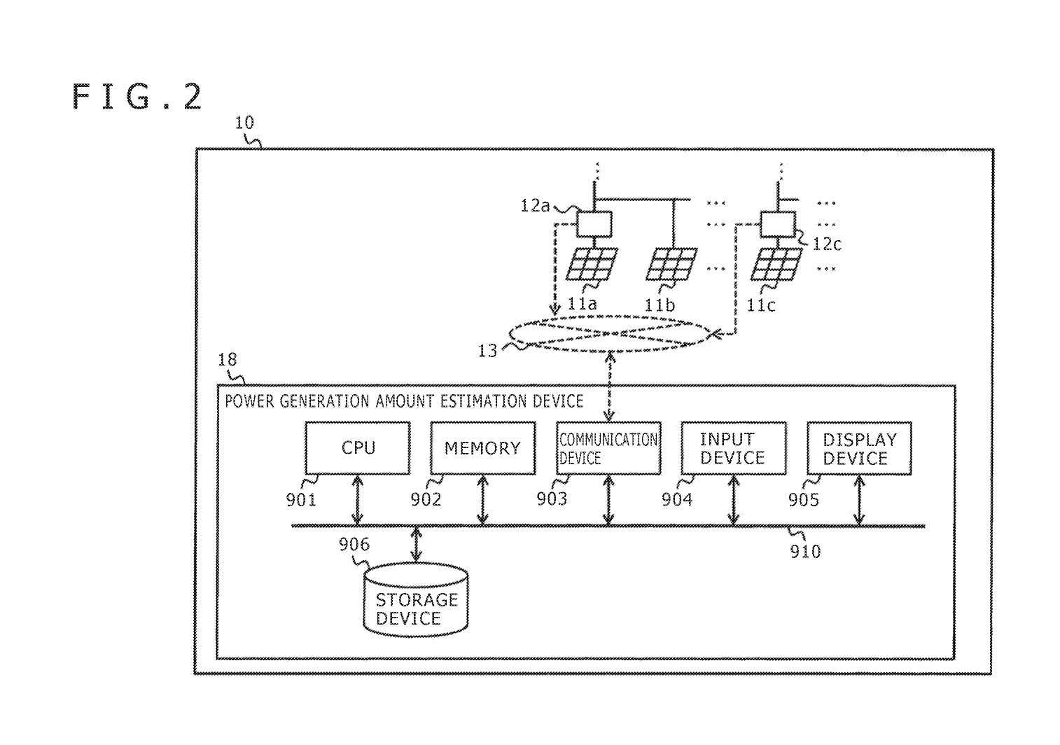

FIG. 2 is a schematic diagram of the configuration of the solar power generation estimation system 10. The solar power generation estimation system 10 includes: photovoltaic power generation devices (hereinafter referred to as “PV devices”) 11a, 11b, and 11c; power sensors 12a and 12c; the power generation amount estimation device 18; and the communication network 13. The power sensor 12 and the power generation amount estimation device 18 are connected by the communication network 13. The PV device 11a, 11b, or 11c may also be referred to as the PV device 11. The power sensors 12a and 12c may also be referred to as the power sensor 12.

The communication network 13 is a network that can transmit data in both directions. For example, the communication network 13 is implemented as a wired network, a wireless network, or a combination of the two. The communication network 13 may be the so-called Internet or may be the network of dedicated lines.

The PV device 11 generates electric power for the amount corresponding to the intensity of solar radiation. The PV device 11 supplies the generated power to the system through a distribution line.

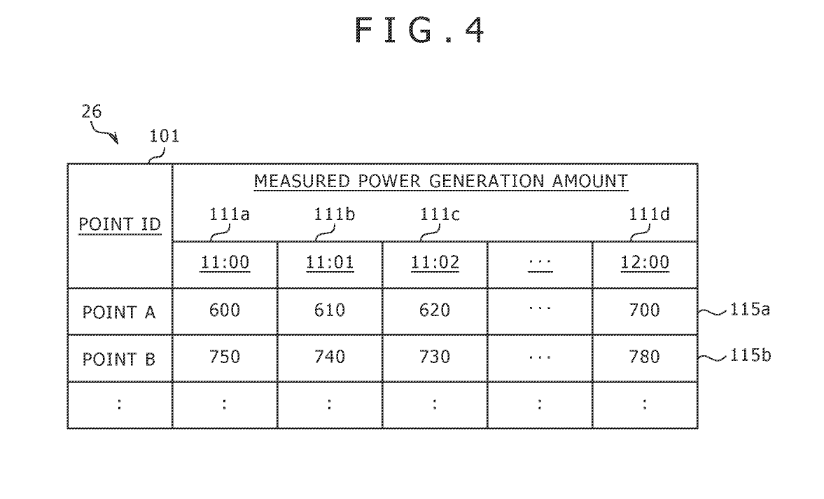

The power sensor 12 measures the amount of power generated by the PV device 11 at regular time intervals (for example, every one second). Then, the power sensor 12 transmits the information on the measured amount of power generation (hereinafter referred to as “measurement information”) 115 (refer to FIG. 4) to the power generation amount estimation device 18 through the communication network 13. The power sensor 12 can be placed inside a pole mounted transformer or a circuit breaker, and the like.

The power generation amount estimation device 18 receives and stores the measurement information 115 transmitted from the power sensor 12. Then, the power generation amount estimation device 18 predicts the total amount of power generation of each PV device 11 installed in a predetermined area at a predetermined time. At this time, with respect to the PV device 11 not including the power sensor 12 (for example, the PV device 11b in FIG. 2), the power generation amount estimation device 18 estimates the power generation amount at the predetermined time by the method described below. The details of the power generation amount estimation device 18 will be described below. The following shows an example of the hardware configuration of the power generation amount estimation device 18.

The power generation amount estimation device 18 includes, for example, a CPU (Central Processing Unit) 901, a memory (Random Access Memory) 902, a communication device 903, an input device 904, a display device 905, and a storage device 906. These elements 901 to 906 are connected by a bus 910 that can transmit data in both directions.

The CPU 901 executes the content described in a computer program (hereinafter referred to as “program”) to realize each of the functions described below. The details of the various functions will be described below.

The memory 902 temporarily stores data necessary for the execution of the program in the CPU 901. The memory 902 is configured by, for example, DRAM (Dynamic Random Access Memory) and the like.

The communication device 903 controls transmission and reception of data through the communication network 13. For example, the communication device 903 obtains the measurement information 115 from the power sensor 12 through the communication network 13.

The display device 905 is a so-called man-machine interface device that can present various types of information to the user. The display device 905 is configured by, for example, a display or a speaker and the like. The various types of information displayed on the display device 905 will be described below.

The input device 904 is a so-called human interface device that can receive input from the user. The input device 904 is configured by, for example, a keyboard, a mouse, or a button and the like. The user can set and change various parameters and can also instruct the execution of the various functions, through the input device 904. Further, the user can display given data on the display device 905 through the input device 904.

The storage device 906 stores various programs and data. The storage device 906 is configured by, for example, HDD (Hard Disk Drive) or a flash memory 902, and the like. For example, the storage device 906 stores programs and data that can realize the various functions described below. The programs and data stored in the storage device 906 are read in the CPU 901 and executed as appropriate.

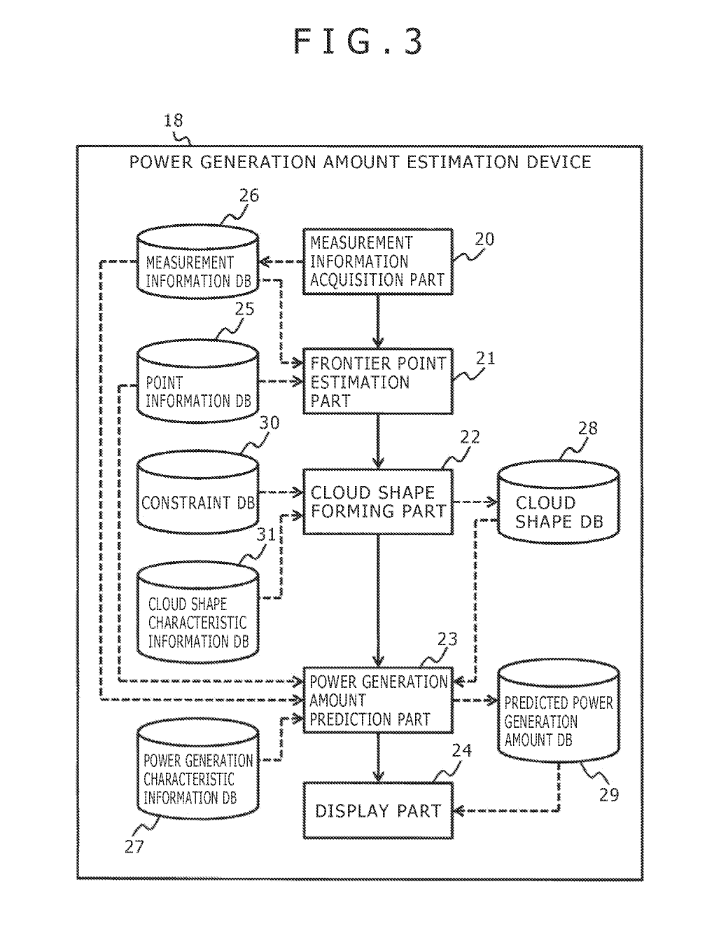

FIG. 3 is a block diagram showing an example of the functional configuration of the power generation amount estimation device 18. The power generation amount estimation device 18 includes a measurement information acquisition part 20, a frontier point estimation part 21, a cloud shape forming part 22, a power generation amount prediction part 23, and a display part 24. Further, the power generation amount estimation device 18 includes a measurement information DB 26, a point information DB 25, a constraint DB 30, a cloud shape characteristic information DB 31, a power generation characteristic information DB 27, a boundary line DB 28, and a predicted power generation amount DB 29. The functions 20 to 24 are realized by executing the corresponding programs by the CPU 901. The DBs 25 to 31 are configured, for example, in the storage device 906.

The measurement information acquisition part 20 receives the measurement information 115 from the power sensor 12 and registers the information in the measurement information DB 26.

FIG. 4 is an example of the data table configured in the measurement information DB 26. The measurement information DB 26 stores and manages one or more measurement information values 115a, 115b, and so on. The measurement information values 115a, 115b, and so on may also be referred to as the measurement information 115. The measurement information 115 includes the following data times, for example: a point ID 101 and power generation amounts 111a, 111b, and so on measured at each time. Each of the power generation amounts 111a, 111b, and so on at each time may also be referred to as the power generation amount 111.

The point ID 101 is the value for uniquely identifying the point at which the PV device 11 is installed. The point ID 101 may be the identification information of the PV device 11 or the identification information of the point (for example, the address or name, and the like, of the point). Each power generation amount 111 is the amount of power generated by the PV device 11 identified by the point ID 101, at each time.

The measurement information 115a shown in FIG. 4 shows that the power generation amount 111 at “11:00” in the PV device 11 located at “point A” is “600”, and the power generation amount at “11:01” is “610”.

Note that the power generation amount 111 at each time may be deleted appropriately from the old data. Now, refer back to FIG. 3.

The frontier point estimation part 21 extracts the frontier point of the cloud (edge point of the cloud) in a predetermined area at a predetermined time. The boundary of the cloud is the boundary between the shadowed area and the non-shadowed area when the cloud is projected on the ground as descried above. The frontier point estimation part 21 extracts the frontier point of the cloud based on the change in the amount of power generated by the PV device 11 at each point. Hereinafter, the method will be described.

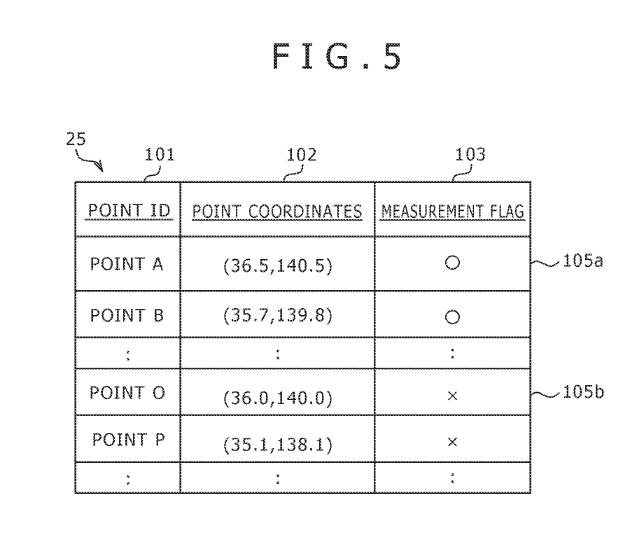

FIG. 5 is an example of the data table configured in the point information DB 25. The point information DB 25 stores and manages one or more values of the point information 105. The point information 105 includes the following data items, for example: the point ID 101, point coordinates 102, and measurement flag 103.

The details of the point ID 101 are as described above. The point coordinates 102 are values indicating the coordinates of the point indicted by the point ID 101. For example, the point coordinates 102 are expressed as latitude and longitude. The measurement flag 103 is the flag indicating whether the power generation amount of the PV device 11 corresponding to the point ID 101 can be measured. In FIG. 5, the “white circle” shows the case in which the power generation amount is measured, while the “cross mark” shows that the case (of non-measurement) in which the power generation amount is not measured. The measurement flag 103 of the PV device 11 not including the power sensor 12 is typically “non-measurement”. Further, even if the PV device 11 includes the power sensor 12, if the measurement information 115 may not be obtained (for example, due to the failure of the communication network 13 or other causes), the measurement flag 103 of the particular PV device 11 is “non-measurement”.

For example, the point information value 105a shown in FIG. 5 shows that the point coordinates 102 for the point ID 101 “point A” is “36.5 degree latitude and 140.5 degree longitude”, and that the power generation amount of the PV device 11 corresponding to the particular point is measured. Further, the point coordinates 102 of the point ID 101 “point O” are “36.0 degree latitude and 140.0 degree longitude”, and that the power generation amount of the PV device 11 corresponding to the particular point ID 101 is not measured.

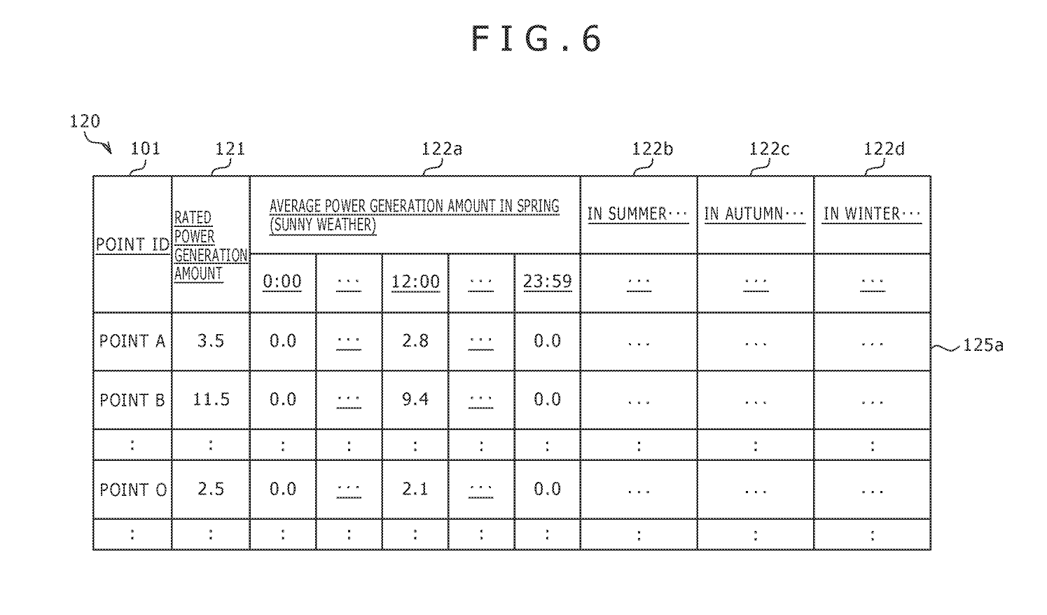

FIG. 6 is an example of the data table configured in the power generation characteristic information DB. The power generation characteristic information 125 includes the following data items, for example: the point ID 101, a rated power generation amount 121, and seasonal power generation amounts 122a to 122d. The seasonal power generation amounts 122a to 122d may also be referred to as seasonal power generation amount 122.

The details of the point ID 101 are the same as described above. The rated power generation amount 121 is the rated power generation amount of the PV device 11 indicated by the point ID 101. The seasonal power generation amount 122 is the average (standard) power generation amount at each time in sunny weather in each season. The seasonal power generation amount 122 is necessary for the setting of the threshold value for change point direction, which will be described below. This is because the power generation amount in sunny weather may differ according to seasons even at the same time, so that it is necessary to adjust the threshold value for change point direction of the power generation amount for each season.

For example, the power generation characteristic information 125a shown in FIG. 6 shows that the rated power generation amount of the PV device 11 with “point A” for the point ID value is “3.5”, and that the average power generation amount 122 at 12 o'clock in sunny weather in spring is “2.8”.

Next, it is described the method for the frontier point estimation part 21 to extract the frontier point of the cloud based on the measurement information 115 and the point information 105.

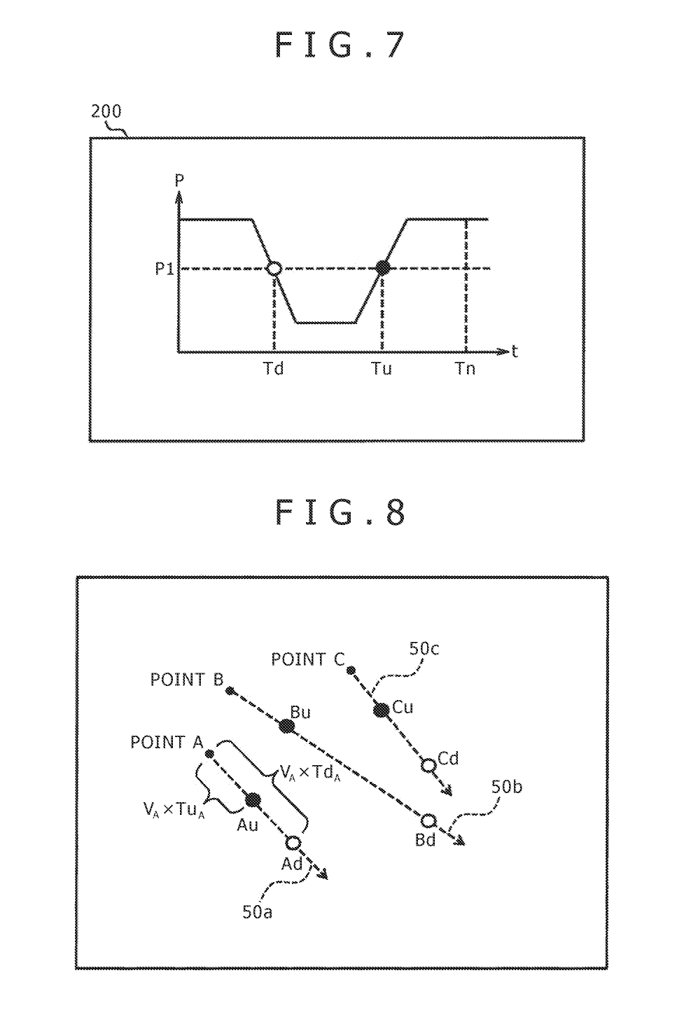

FIG. 7 is a graph showing the temporal transition of the amount of power generated in the PV device 11 at a certain point. In the graph 200, the horizontal axis represents the time t when the current time is “Tn=0”, and the vertical axis represents the power generation amount P. In the graph 200, the power generation amount P is significantly reduced more at a past time Td than the current time Tn (Td<Tn). Then, the reduced power generation amount P continues to a time Tu that is future relative to the time Td (Td<Tu<Tn). The power generation P significantly increases at the time Tu. From this fact, it can be estimated that the point of the PV device 11 shown in the graph 200 has been covered by the cloud from the time Td to the time Tu. The following describes the process for detecting the time when the power generation amount P has changed more than a predetermined amount.

First, the frontier point estimation part 21 sets a threshold value for change point direction P1, which is the threshold value of the power generation amount to determine whether a certain point is covered by the cloud. The frontier point estimation part 21 extracts an increasing time Tu₁ that satisfies the following equations 1 and 2.

P1−ε≦(Tuᵢ)≦P1+ε (equation 1)

P(Tuᵢ₋₁)<P(Tuᵢ)<P(Tuᵢ₊₁) (equation 2)

Here, “i” is a positive integer indicating the measurement order. In other words, “i−1” is the measurement time previous to the measurement time “i”, and “i+1” is the measurement time next to the measurement time “i”. Further, “c” is a predetermined value that defines the range neighboring the threshold value for change point direction P1.

That is, the frontier point estimation part 21 extracts only the increasing time Tu; with the power generation amount approximately equal to the threshold value for change point direction P1, in which the power generation amount increases as time passes, by the equations 1 and 2.

Similarly, the frontier point estimation part 21 extracts a decreasing time Td₁ that satisfies the following equations 3 and 4 at a certain point.

P1−ε≦P(Tdᵢ)≦P1+ε (equation 3)

P(Tdᵢ₋₁)>P(Tdᵢ)>P(Tdᵢ₊₁) (equation 4)

That is, the frontier point estimation part 21 extracts only the decreasing time Td₁ with the power generation amount approximately equal to the threshold value for change point direction P1, in which the power generation amount decreases as time passes, by the equations 3 and 4.

The threshold value for change point direction P1 of the equations 1 and 3 may differ at each point. The threshold value for change point direction P1 of the equation 1 and the threshold value for change point direction P1 of the equation 3 may be different. The threshold value for change point direction P1 may be set based on the power generation characteristic information 125 of the PV device 11 at each point stored in the power generation characteristic information DB 27. For example, the frontier point estimation part 21 may set the threshold value for change point direction P1 to a value α times (0<α<1) the rated power generation amount 121. Alternatively, the frontier point estimation part 21 may set the threshold value for change point direction P1 to a value α times (0<α<1) the average power generation amount 122 in sunny weather at a time when the power generation amount is predicted.

The frontier point estimation part 21 may extract the increasing time Tu and the decreasing time Td after applying a so-called low-pass filter to the graph showing the temporal changes of the power generation amount. It is also possible that the frontier point estimation part 21 calculates the movement average of the measured power generation amount 111, to extract the increasing time Tu and the decreasing time Td for the particular movement average value. This is in order for the frontier point estimation par 21 not to extract the increasing time Tu or the decreasing time Td for the rapid increase and decrease of the power generation amount in a short time.

The frontier point estimation part 21 performs the above process for each point to extract the increasing time Tu and the decreasing time Td for each point. The frontier point estimation part 21 estimates the frontier point of the cloud at a predetermined time based on the increasing time Tu and the decreasing time Td. Hereinafter, the method will be described.

FIG. 8 is a schematic diagram illustrating the wind speed and direction at measurement points. Each of the arrows 50a to 50c of the dotted lines passing through the points shown in FIG. 8 indicates the wind direction at each measurement point. In general, the frontier point of the cloud is assumed to move at a speed proportional to the wind speed along the direction of the wind. Thus, the frontier point estimation part 21 estimates the point to which the frontier point of the cloud, which is extracted at the increasing time Tu (or the decreasing point Td) at the measurement point, moves at the predicted time after a predetermined time passes from the increasing time Tu (or the decreasing time Td) based on the wind direction and speed. For example, the predicted time may be the current time or a predetermined time after the current time.

It is assumed that the decreasing time at the point A is Td_{A} and the increasing time is Tu_{A}. The frontier point estimation part 21 obtains information that the wind speed at the point A from the decreasing time Td to the predicted time is “V_{A}” in the wind direction of a “north-west to south-east direction”, from a predetermine information source. The frontier point estimation part 21 estimates that the frontier point of the cloud passing through the point A at the decreasing time Td_{A} (hereinafter referred to as the “decreasing frontier point”) moves from the point A to a point Ad of “V_{A}×Td_{A}” in the “north-west to south-east direction” at the predicted time. Similarly, the frontier point estimation part 21 estimates that the frontier point of the cloud passing through the point A at the increasing time Tux (hereinafter referred to as the “increasing frontier point”) moves from the point A to a point Au of “V_{A}=Tu_{A}” in the “north-west to south-east direction” at the predicted time.

With respect to the points B and C, the frontier point estimation part 21 estimates the decreasing frontier points Bd and Cd, as well as the increasing frontier points Bu and Cu at the predicted time, respectively, by the same process.

The wind direction and speed are obtained, for example, by using the information released by the meteorological observing station, and the like. Alternatively, when a wind power station or an anemometer is installed in the vicinity of the measurement point, it is possible to use the wind direction and speed information that is measured by the wind power station or the anemometer. Now, refer back to FIG. 3.

The cloud shape forming part 22 estimates the shape of the cloud at the current time or a certain time in the future, based on the decreasing and increasing points estimated by the frontier point estimation part 21 at the current time or a certain time in the future. In other words, the cloud shape forming part 22 forms a (closed curve shaped) boundary line illustrating the shape (namely, the outline) of the cloud. Hereinafter, the method for forming the boundary line will be described.

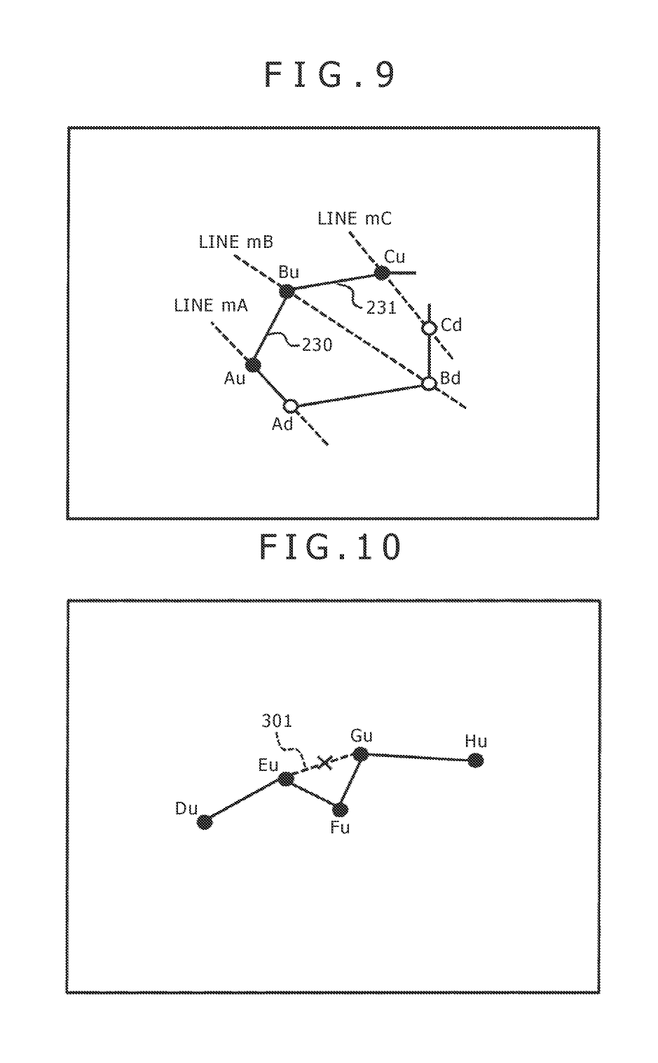

FIG. 9 is a schematic diagram illustrating the decreasing points and the increasing points in the current time. The decreasing points Ad, Bd, and Cd, as well as the increasing points Au, Bu, and Cu at the current time TN are estimated by the frontier point estimation part 21 as described above. Then, the cloud shape forming part 22 forms a closed curve shaped boundary line based on the decreasing points and the increasing points. Hereinafter, the method for forming the boundary line will be described.

The cloud shape forming part 22 searches for other points located in the vicinity of a certain frontier point. Then, the cloud shape forming part 22 forms a part of the boundary line (hereinafter referred to as a “line segment”) by connecting the certain frontier point and the other frontier point that is the closest to the particular frontier point. Similarly, the cloud shape forming part 22 forms a line segment by connecting the certain frontier point and the other frontier point that is the second closest to the particular frontier point. At this time, the cloud shape forming part 22 connects decreasing boundary lines or increasing boundary lines to each other.

For example, the point Bu in FIG. 9 is connected to the closest point Au to form a line segment Bu-Au (line segment 230). Similarly, the point Bu is connected to the second closest point Cu to form a line segment Bu-Cu. In FIG. 9, the boundary line is shown by the straight line. However, the boundary line may be an appropriate curve.

By performing the above process at each frontier point, the cloud shape forming part 22 can form the decreasing boundary line connecting the decreasing points, as well as the increasing boundary line connecting the increasing points.

However, the cloud shape forming part 22 forms the boundary line based on the given constraints. Hereinafter, the constraints will be described.

A first constraint is that the line segment does not cross a line extending from each measurement point in the direction of the wind (for example, line mA, line mB, or line mC and the like in FIG. 9, hereinafter referred to as “wind direction line”) (however, the wind direction line on the frontier point is not applied here).

The case in which the cloud shape forming part 22 forms a line segment from the point Au will be described as an example. The cloud shape forming part 22 forms a line segment Au-Bu with the point Bu that is the closest to the point Au. The line segment Au-Bu does not run counter to the first constraint. However, when the cloud shape forming part 22 forms a line segment Au-Cu with the point Cu that is the second closest to the point Au, the line segment Au-Cu crosses the wind direction line mB and runs counter to the first constraint. Thus, the cloud shape forming part 22 determines that the line segment Au-Cu is inappropriate. In this case, the cloud shape forming part 22 tries to form a line segment connecting an increasing point and a decreasing point that are present on the same wind direction line. For example, the cloud shape forming part 22 tries to form a line segment Au-Ad connecting the increasing point Au and the decreasing point Ad on the same wind direction line mA.

A second constraint is that line segments connecting frontier points are formed in such a way that the line segments do not overlap or cross each other. The second constraint will be further described below.

FIG. 10 is a schematic diagram illustrating the second constraint. In FIG. 10, points Du, Eu, Fu, Gu, and Hu are all increasing points. Then, the other increasing points close to the increasing point Eu are the increasing points Fu and Gu. The other increasing point close to the increasing point Gu is the increasing points Eu and Fu. It is assumed that the increasing point Eu forms line segments Eu-Fu and Eu-Gu, and the increasing point Gu forms line segments Gu-Eu and Gu-Fu. In this case, the line segment Eu-Gu (line segment 301) is redundant and runs counter to the second constraint. In such a case, the cloud shape forming part 22 tries to reform the line segment in such a way that the line segment is not redundant. For example, the cloud shape forming part 22 prohibits the formation of the redundant line segment and tries to reform the line segment.

Note that instead of (or in addition to) the above condition, the second constraint can be defined as follows. No closed curve occurs by a set of boundary lines connecting only increasing points or only decreasing points. If a closed curve occurs in this condition, the cloud shape forming part 22 deletes one of the line segments forming the closed curve, in order to form one boundary line formed only by increasing points or decreasing points. For example, in the case of FIG. 10, it is possible to form one boundary line Du-Eu-Fu-Gu-Hu that is formed only by increasing points by deleting the line segment Eu-Gu (line segment 301).

A third constraint is that the line segment between increasing points or decreasing points is shorter than a predetermined length (distance), and that the distance between a certain line segment and the other line segment is longer than a predetermined length (distance). This is because, if the line segment runs counter to the third constraint, there is a high possibility that the boundary line formed by the particular line segment does not properly illustrate the shape of the cloud. The third constraint will be further described below.

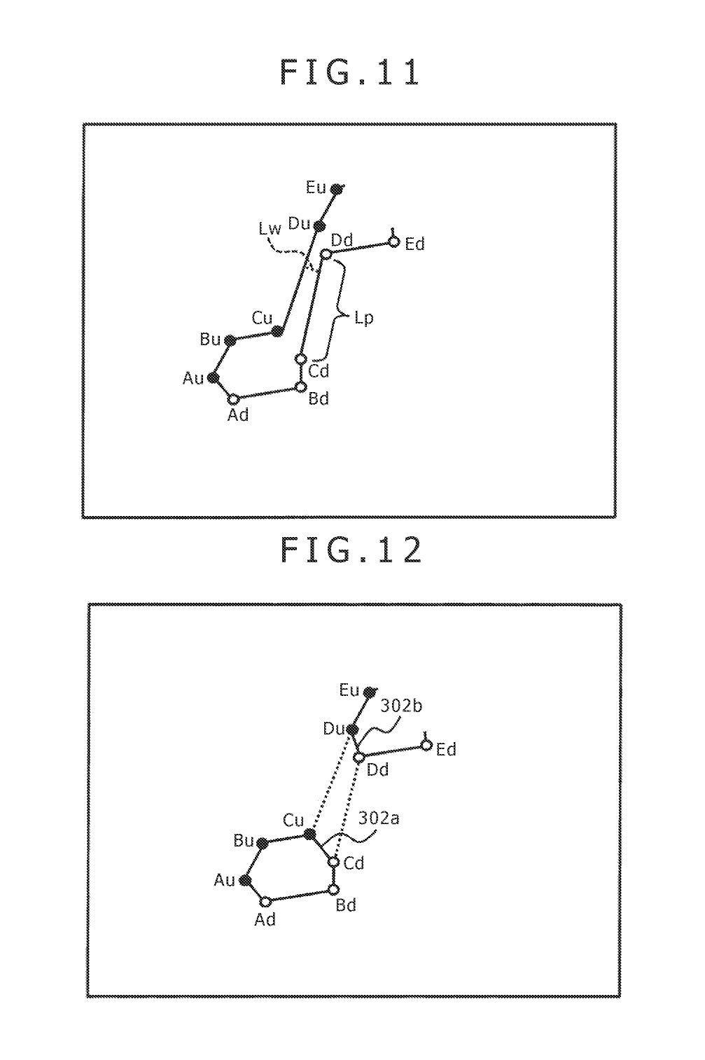

FIG. 11 is a schematic diagram illustrating the third constraint. In FIG. 11, it is assumed that a length Lp of a line segment Cd-Dd is longer than a predetermined length LA (Lp>LA). In this case, the cloud shape forming part 22 determines that the line segment Cd-Dd that runs counter to the third constraint is inappropriate to illustrate the shape of the cloud. Further, in FIG. 11, it is assumed that a distance Lw between the line segment Cu-Du and the line segment Cd-Dd is shorter than a predetermined distance LB (Lw<LB). In this case, the cloud shape forming part 22 determines that the line segment Cu-Du and/or the line segment Cd-Dd that runs counter to the third constraint is inappropriate to illustrate the shape of the cloud. As described above, if it is determined that the formed line segment is inappropriate, the cloud shape forming part 22 performs, for example, the following process.

FIG. 12 is a schematic diagram illustrating the method for correcting the boundary line that runs counter to the third constraint. The cloud shape forming part 22 determines that the line segment Cu-Du and the line segment Cd-Dd are inappropriate. Thus, the cloud shape forming part 22 tries to form other line segments that satisfy the third constraint. For example, the cloud shape forming part 22 forms a line segment Cu-Cd (line segment 302a) connecting the increasing point Cu and the decreasing point Cd. Similarly, the cloud shape forming part 22 forms a line segment Du-Dd (line segment 302b) connecting the increasing point Du and the decreasing point Dd. In other words, it can be said that the third constraint is also the judgment standard to find the point at which one cloud model is divided into two cloud models.

A fourth constraint is that the closed curve formed by an increasing boundary line, a decreasing boundary line, and a line segment connecting these boundary lines has a predetermined similarity, or more, to a general cloud shape. In other words, the fourth constraint determines whether the formed cloud shape model has a predetermined similarity, or more, to the general cloud shape model.

For example, the general cloud shape model is stored in the cloud shape characteristic information DB 31 in advance. Then, the cloud shape forming part 22 calculates the similarity between the formed closed curve and each of the cloud shape models stored in the cloud shape characteristic information DB 31. Here, if the formed closed curve does not have a predetermined similarity, or more, to any of the cloud shape models (namely, if there is no similar cloud model), the cloud shape forming part 22 determines that the formed closed curve does not properly illustrate the cloud shape. This is because there is little possibility of forming a cloud whose shape is extremely different from the general cloud shape.

A fifth constraint is that the closed curve formed for a predetermined time has a predetermined similarity, or more, to the closed curve formed for a predetermined time a little before that time. For example, the cloud shape forming part 22 allows the closed curve formed for each predetermined time to be stored in the boundary line DB 28. Then, the cloud shape forming part 22 calculates the similarity between the formed closed curve and the closed curve before predetermined time stored in the boundary line DB 28. Here, if the formed closed curve does not have the predetermined similarity or more, the cloud shape forming part 22 determines that the formed closed curve does not properly illustrate the cloud shape. This is because there is little possibility that the cloud shape will be extremely deformed in a short time.

A sixth constraint is that the difference between the area of the region surrounded by the closed curve formed for a predetermined time, and the area surrounded by the closed curve formed for a predetermined time a little before that time, is a predetermined value or less. For example, the cloud shape forming part 22 allows the closed curve formed for each predetermined time to be stored in the boundary line DB 28. Then, the cloud shape forming part 22 calculates the difference between the area of the formed closed curve and the area of the closed curve before predetermined time stored in the boundary line DB 28. Here, if the difference is a predetermined threshold or more, the cloud shape forming part 22 determines that the formed closed curve does not properly illustrate the cloud shape. This is because there is little possibility that the area of the cloud will change significantly in a short time.

With respect to the first to sixth constraints described above, one, a combination or all of these constraints can be applied.

For example, it is possible to apply a combination of the first and second constraints. In this way, the cloud shape forming part 22 can form a closed curve showing the boundary line of the cloud. For example, it is also possible to apply the third constraint by combining it with the first and second constraints. In this way, the cloud shape forming part 22 can form a closed curve showing the boundary line of the cloud with a higher accuracy. For example, the cloud shape forming part 22 can also apply the first, second, and third constraints by further combining them with the fourth, fifth, and/or sixth constraints. In this way, the cloud shape forming part 22 can form a closed curve showing the boundary line of the cloud with a much higher accuracy.

Further, each of the constraints can be set differently for each area. It is also possible that a predetermined weight is set for each constraint in advance, to calculate the accuracy of the closed curve showing the boundary line of the cloud, based on how much the closed curve satisfies each constraint.

Based on the constraints described above, the cloud shape forming part 22 forms one or more closed curves. In other words, it can be assumed that each formed closed curve illustrates the shape of the cloud shape as well as the point where the cloud exists at the current time or a certain time in the future. Now, refer back to FIG. 3.

The power generation amount prediction part 23 estimates the power generation amount of the non-measurement PV device 11 based on the closed curve formed by the cloud shape forming part 22 (namely, based on the closed curve illustrating the point and shape of the cloud). The process of the power generation amount prediction part 23 will be further described below.

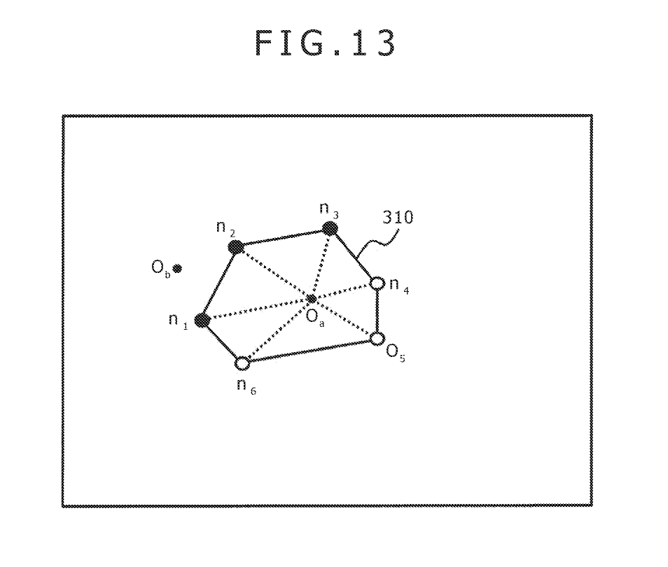

FIG. 13 is a schematic diagram illustrating the method for determining whether a certain point is located within the closed curve. The power generation amount prediction part 23 determines whether a point O of the non-measurement PV device 11 is located within the closed curve 310. In this determination, for example, the following equation 5 is used. Here, M is the number of frontier points forming the closed curve. Then, it is assumed that n_{M+1}=n₁.

$$\begin{matrix}[ Formula 1 ] & \\ {\sum }_{k = 1}^{M} ∠ {n}_{k} {on}_{k + 1} = \{ \begin{matrix}2 π & ( within the closed curve ) \\ 0 & ( outside the closed curve )\end{matrix} & ( equation 5 )\end{matrix}$$

When the closed curve 310 is applied to the equation 5, the following equation is obtained: Corner n₁Oₐn₂+Corner n₂Oₐn₂>+ . . . +Corner n₆Oₐn=2π. Thus, it is possible to determine that a point Oₐ is located within the closed curve 310. Further, since Corner n₁O_{b}n₂+Corner n₂O_{b} n₂+ . . . +Corner n₆O_{b}n=0, it is possible to determine that a point Or is located outside the closed curve 310.

The above process is applied to determine for the point of each non-measurement PV devices 11. Then, the point that is located within any of the closed curves is defined as the interior point, and the point that is not located within any of the closed curves is defined as the exterior point.

Next, the method for estimating the power generation amount at the interior and exterior points of the closed curve will be described. The interior point is likely to be covered by the cloud, so that the amount of solar radiation can be estimated to be small. The exterior point is not likely to be covered by the cloud, so that the amount of solar radiation can be estimated to be large. Thus, the power generation amount at the interior point can be estimated to be smaller than the threshold value for change point direction P1 used by the frontier point estimation part 21. The power generation amount at the exterior point can be estimated to be greater than the threshold value for change point direction P1. Thus, for example, the power generation amount at the interior point is estimated to be P1×M (M is a predetermined coefficient of 0<M<1). Then, the power generation amount at the exterior point is estimated to be P1×N (N is a predetermined coefficient of N>1). It is also possible to estimate the power generation amount at the interior point based on the power generation amount of the measurable PV device 11 surrounded by the same closed curve as the particular interior point. Further, it is also possible to estimate the power generation amount at the exterior point based on the power generation amount of the measurable PV device 11 that is not surrounded by any closed curve.

With the process described above, it is possible to estimate the power generation amount at the point of the non-measurement PV device 11 at a certain time in the future.

Next, the method for estimating the total power generation amount of the PV device in each area will be described. A first estimation method is to extract the installation points of all the PV devices 11 installed in a predetermined area from the point information DB 25, while estimating the power generation amount for the non-measurement point by the method described above. With the first estimation method, the total power generation amount of all the PV devices 11 in the particular area is estimated. A second estimation method is to extract the average power generation characteristics and the installation density of the PV devices 11 in a predetermined area from the power generation characteristic information DB 27, to estimate the power generation amount by the method described above. The second method will be further described below.

The installation density of the PV devices 11 is defined as ρ. The average power generation amount at a predetermined time is determined as Ps. The estimated power generation amount at the interior point is defined as Ps×R_{low}(0≦R_{low}≦1). The estimated power generation amount at the exterior point is defined as Ps×R_{high}(0≦R_{high}≦1 and R_{high}≧R_{low}). The interior areas of the closed curves Φ1, Φ₂, . . . , #ₙ in a certain area is defined as S₁, S₂, . . . , Sₙ and the area of this area is defined as Sₐₗₗ. Then, the estimated total power generation amount Pₐₗₗ in a certain area is calculated by the following equation 6.

[Formula 2]

Pₐₗₗ=ΣSₖ×p×P_{E}×R_{low}+(Sₐₗₗ−ΣSk)×p×Ps×R_{high} (equation 6)

The first estimation method can estimate the total power generation amount with a relatively high accuracy. On the other hand, the second estimation method can reduce the process load because the amount of data required for the process is small, although the accuracy may be lower than the case of estimation by the first estimation method.

By the process described above, the power generation amount prediction part 23 can estimate the total power generation amount (hereinafter referred to as the “predicted total power generation amount”) of the PV device 11 in a predetermined area, including non-measurement points, at a predetermined time. The estimated total power generation amount is used for controlling the power supply in consideration of power generation of the PV device 11. Now, refer back to FIG. 3.

The predicted power generation amount DB 29 stores and manages the predicted power generation amount estimated by the power generation amount prediction part 23. The display part 24 extracts the predicted power generation amount of each PV device 11 at a predetermined time from the predicted power generation amount DB 29, and displays the extracted information. The display part 24 extracts the predicted total power generation amount in a predetermined area at a predetermined time from the predicted power generation amount DB 29, and displays the extracted information. Further, the display part 24 displays the formed closed curve superimposed on the map. In this way, the user can visually understand the magnitude of the solar radiation amount and the magnitude of the power generation amount. Further, the display part 24 displays the temporal transition of the closed curve so that the user can visually understand the change in the solar radiation amount and the power generation amount in the area.

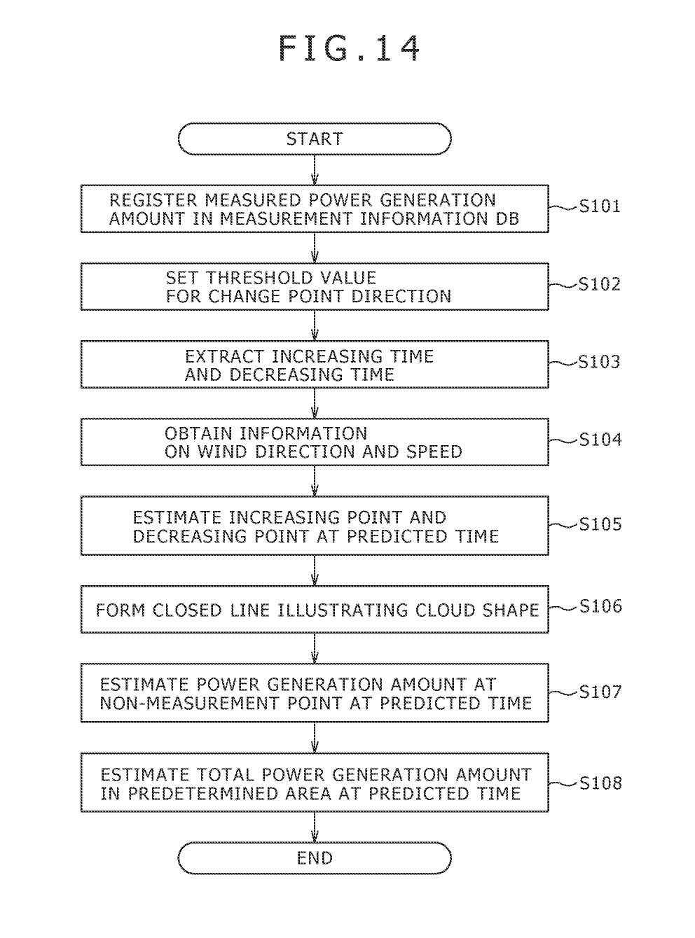

FIG. 14 is a flow chart showing an example of the process for the power generation amount estimation device 18 to estimate the predicted power generation amount.

The measurement information acquisition part 20 registers the power generation amount measured by the power sensor 12 of each PV device 11 into the measurement information DB 26 (S101).

The frontier point estimation part 21 extracts the power generation characteristics at each point from the power generation characteristic information DB 27, and sets the threshold value for change point direction P1 at a predetermined time based on the extracted power generation characteristics (S102).

The frontier point estimation part 21 extracts the power generation amount at each measurement point from the measurement information DB 26, and extracts the increasing time and the decreasing time by using the threshold value for change point direction P1 (S103).

The frontier point estimation part 21 obtains the information on the wind speed and direction at each measurement point (S104).

The frontier point estimation part 21 estimates the increasing point and the decreasing point at the current time or a certain time in the future (hereinafter referred to as “predicted time”) based on the information on the increasing time, the decreasing time, the wind speed and direction, and the like (S105).

The cloud shape forming part 22 forms a closed curve illustrating the cloud shape based on multiple increasing frontier points, decreasing frontier points, and various constraints (S106).

The power generation amount prediction part 23 estimates the power generation amount at each non-measurement point at the predicted time, by extracting the non-measurement point from the point information DB 25, in considering whether the non-measurement point is inside or outside the closed curve (S107).

The power generation amount prediction part 23 estimates the total power generation amount in a predetermined area based on the power generation estimated at each point, and registers in the predicted power generation amount DB 29 (S108).

By the process described above, it is possible to estimate the total power generation amount in the predetermined area at the current time or a certain time in the future. For example, the estimated total power generation amount can be used for adjusting and controlling the supply and demand for the power system.

Next, the case in which two threshold values for change point direction are set will be described as a variation in the formation of the closed curve.

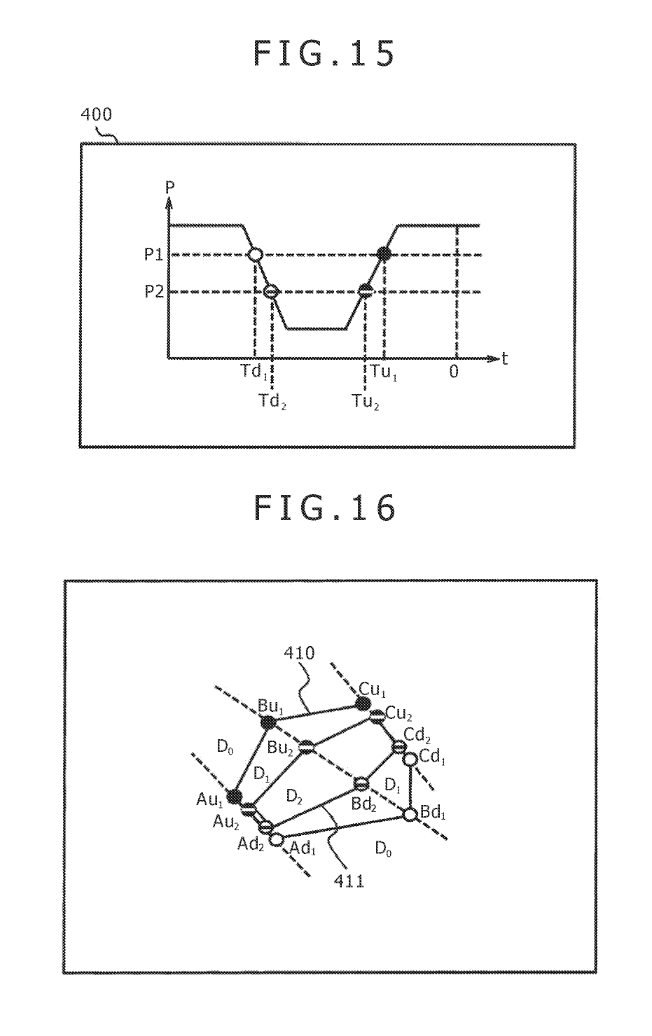

FIG. 15 is a graph showing the temporal transition of the power generation amount when two threshold values for change point direction are set. Different from the graph 200 shown in FIG. 7 in which only one threshold value for change point direction is set, two threshold values for change point direction are set in a graph 400 shown in FIG. 15.

The graph 400 shows the temporal transition of the power generation amount of the PV device 11 located at the point A. In the graph 400, it is assumed that P1>P2, and that the power generation amount in sunny weather is Ps. In this case, for example, it can be defined as P1=Ps×α, P2=Ps×β(0<β<α<1).

The frontier point estimation part 21 extracts the increasing time Tu, corresponding to P1, as well as the increasing time Tu₂ corresponding to P2 by using the equations 1 and 2. Similarly, the frontier point estimation part 21 extracts the decreasing time Pd₁ corresponding to P1, as well as the decreasing time Pd₂ corresponding to P2 by using the equations 3 and 4.

The frontier point estimation part 21 estimates the increasing points Au₁ and Au₂, respectively, corresponding to the increasing times Tu: and Tu₂ at the predicted time, based on the information on the wind direction and speed. Similarly, the frontier point estimation part 21 estimates the decreasing point Ad₁ and Ad₂, respectively, corresponding to the decreasing times Td: and Td₂ at the predicted time.

FIG. 16 is a schematic diagram illustrating a variation of the frontier points and the closed curves at the predicted time.

The cloud shape forming part 22 forms a closed curve by connecting the increasing point and the decreasing point that correspond to the same threshold value for frontier point. In other words, if multiple threshold values for change point direction are set, the cloud shape forming part 22 forms multiple closed curves. Here, the cloud shape forming part 22 forms closed curves so that the closed curves do not cross (overlap) each other. In the case of FIG. 16, the cloud shape forming part 22 forms a boundary line 410 corresponding to the threshold value for change point direction P1, as well as a boundary line 411 corresponding to the threshold value for change point direction P2.

The power generation amount prediction part 23 estimates the power generation amount at the non-measurement point by using multiple closed curves formed by the cloud shape forming part 22. When one non-measurement point is surrounded by two or more closed curves, the power generation amount prediction part 23 estimates the power generation amount by assuming that the non-measurement point is surrounded by the innermost closed curve. The estimation of the power generation amount at this non-measurement point is performed, for example, by the following method.

The area, which is inside a closed curve Cₖ formed by the increasing point Au, and the decreasing point Adₖ and is outside a closed curve Cₖ₊₁ formed by the increasing point Auₖ₊₁ and the decreasing point Adₖ₊₁, is defined as Dₖ. Note that the closed curve Cₖ: is assumed to be contained in the closed curve Cₖ. It is estimated that the solar power generation amount in the area Dₖ is Sₖ. Here, k is an integer taking a value from 0 to N. Whether the non-measurement point exists in the area Dₖ is determined by whether the non-measurement point exists inside the closed curve Cₖ and outside the closed curve Cₖ₊₁, by using the formula 5. Further, Sₖ is a representative value of the solar power generation amount in the area Dₖ, and the value satisfying Pₖ≧Sₖ≧Pₖ₊₁ (where P1>P2> . . . >Pn) is set in advance.

For example, in FIG. 16, the area outside the closed curve Au₁-Bu₁ . . . Bd₁-Ad₁ (boundary line 410) is defined as D₀. The area inside the closed curve Au₁-Bu₁ . . . Bd₁-Ad₁ (boundary line 410) and outside the closed curve Au₂-Bu₂ . . . Bd₂-Ad₂ (boundary line 411) is defined as D₁. The area inside the Au₂-Bu₂ . . . Bu₂-Au₂ (boundary line 411) is defined as Dz. Then, the power generation amount prediction part 23 determines which one of areas D₀, D₁, and D₂ includes the non-measurement point. Then, the power generation amount prediction part 23 estimates the power generation amount at the non-measurement point based on each of the areas corresponding to S₀, S₁, and S₂.

By the process described above, it is possible to estimate the power generation amount of the non-measurement PV device 11 by setting two or more threshold values for change point direction. By increasing the number of threshold values for change point direction, it is possible to estimate the power generation amount in consideration of the influence of the cloud on the solar radiation amount more precisely. As a result, it is possible to increase the estimation accuracy of the power generation amount of the PV device 11.

It is understood that the embodiments of the present invention are illustrative, and should not be construed to limit the scope of the invention. Thus, a person skilled in the art can implement the invention in various alternative ways within the scope of the attached claims.

For example, the cloud shape estimation model at a predicted time in a predetermined area may be used in the weather forecast for this area. For example, the predicted power generation amount at a predicted time may be fed back to each home for use in power control for each home.

Note that the above embodiment can also be expressed, for example, as follows. A power generation amount estimation system includes: a storage part for storing data; a data acquisition part for obtaining a measured value that changes according to the amount of solar radiation at each time, from each of multiple measurement points in a predetermined area, and storing the measured values in the storage part as time series data; a data extraction part for extracting the time series data of the measured value that has been measured in a predetermined first period of time and is included in a predetermined range, the measured value having a predetermined change in the first period of time, from the storage part; a frontier point identification part for identifying the measurement point corresponding to the extracted time series data as a first frontier point, with respect to each of the extracted time series data; a frontier point prediction part for predicting the destination point of the first frontier point in a second period of time after a predetermined time from the first period of time, as a second frontier point, based on the environment information which is given information on the environment, with respect to each of the identified first frontier points; a boundary line forming part for forming a second boundary line with a closed curve shape, based on the predicted multiple second frontier points; and a power generation amount prediction part for predicting the power generation amount of a PV device installed in the predetermined area in the second period of time, based on the second boundary line.

Although the foregoing description has been made on the embodiment of the invention, it will be apparent for those skilled in the art that modifications and variations may be made in the invention without departing from the spirit of the invention and the scope of the appended claims.

### LIST OF REFERENCE SINGS

10: Solar power generation estimation system
11: PV device
12: power sensor
13: Communication network
18: Power generation amount estimation device

1-11. (canceled)

12. A solar power generation estimation system for estimating the power generation amount of a photovoltaic power generation device,
wherein the solar power generation estimation system comprises:
a plurality of light receiving devices that are dispersed in a predetermine area and each of which outputs a received light signal corresponding to the amount of received light; and
an estimation device connected to the plurality of light receiving devices through a communication network,
wherein the estimation device includes the steps of:
predicting the cloud shadow projected on the ground based on the received light signal obtained a plurality of times from a predetermined number of light receiving devices of the plurality of light receiving devices;
estimating the amount of power generated by the photovoltaic power generation device installed in the predetermined area, based on the predicted cloud shadow; and
identifying a given received light signal with a predetermined increasing or decreasing trend in a predetermined period of time, from the plurality of received light signals, to predict the cloud shadow boundary which is the boundary formed by the cloud shadow, based on the installation point of the light receiving device that has output the given received light signal.

13. A solar power generation estimation system according to claim 12,
wherein the estimation device predicts the cloud shadow boundary at a certain time further based on the environment information including information on the wind direction and speed.

14. A solar power generation estimation system according to claim 13,
wherein the estimation device estimates the power generation amount of the photovoltaic power generation device at the certain time, based on the positional relationship between the installation point of the photovoltaic power generation device and the cloud shadow boundary at the certain time.

15. A solar power generation estimation system according to claim 14,
wherein the estimation device determiners whether the installation point of the photovoltaic power generation device is included in the shadow area of the cloud shadow boundary at the certain time, and if the determination is affirmative, estimating that the power generation amount of the photovoltaic power generation device at the certain time is a predetermined value or less.

16. A solar power generation estimation system according to claim 13,
wherein the estimation device comprises the steps of:
estimating that a part of the cloud shadow boundary passes through the installation point of the light receiving device that has output the given received light signal, in the predetermined period of time when the given received light signal is identified;
defining the part of the cloud shadow boundary passing through the installation point as the cloud shadow frontier point;
estimating the point of destination of the cloud shadow frontier point at the certain time with respect to a plurality of light receiving devices, by using the information on the wind direction and speed included in the environment information; and
estimating the cloud boundary at the certain time based on the estimated destination points of the plurality of cloud shadow frontier points.

17. A solar power generation estimation system according to claim 16,
wherein the cloud shadow boundary at the certain time is the line connecting the destination points of the cloud shadow frontier points to each other,
wherein the estimation device connects the destination points of the cloud shadow frontier points so that the lines do not cross each other.

18. A solar power generation estimation system according to claim 17,
wherein the estimation device connects the destination points of the cloud shadow frontier points further with lines of a predetermined length or less.

19. A solar power generation amount estimation device for estimating the power generation amount of a photovoltaic power generation device,
wherein the solar power generation amount estimation device is connected to a plurality of light receiving devices, which are dispersed in a predetermined area and each of which outputs a received light signal corresponding to the amount of received light, through a communication network,
wherein the solar power generation amount estimation device comprises the steps of:
predicting the cloud shadow projected on the ground based on the received light signal obtained a plurality of times from a predetermined number of light receiving devices of the plurality of light receiving devices;
estimating the amount of power generated by the photovoltaic power generation device installed in the predetermined area, based on the predicted cloud shadow; and
identifying a given received light signal with a predetermined increasing or decreasing trend in a predetermined period of time, from the plurality of received light signals, to predict the cloud shadow boundary, which is the boundary formed by the cloud shadow, based on the installation point of the light receiving device that has output the given received light signal.

20. A solar power generation amount estimation method for estimating the power generation amount of a photovoltaic power generation device,
wherein the solar power generation amount estimation method comprises the steps of:
obtaining a received light signal a plurality of times from a predetermined number of light receiving devices of a plurality of light receiving devices, which are dispersed in a predetermined area and each of which outputs a received light signal according to the amount of received light, through a communication network;
predicting the cloud shadow projected on the ground based on the received signal obtained a plurality of times;
estimating the amount of power generated by the photovoltaic power generation device installed in the predetermined area, based on the predicted cloud shadow; and
identifying a given received light signal with a predetermined increasing or decreasing trend in a predetermined period of time, from the plurality of received light signals, to predict the cloud shadow boundary, which is the boundary formed by the cloud shadow, based on the installation point of the light receiving device that has output the given received light signal.
